(19) United States
(12) Patent Application Publication
(10) Pub. No.: US 2011/0314783 A1
(43) Pub. Date: Dec. 29, 2011

(54) Lawn Mower with Selectively Reversible Cutting Blades

(76) Inventor: Ryan Dewey, Valencia, PA (US)

(21) Appl. No.: 13/168,031

(22) Filed: Jun. 24, 2011

Related U.S. Application Data
(60) Provisional application No. 61/358,117, filed on Jun. 24, 2010.

(51) Int. Cl. A01D 34/13

(52) U.S. Cl. 56/10.8; 56/289

(57) ABSTRACT

An improved lawn mower having the ability to exhaust grass out of a left chute, a right chute, or a rear chute. The improved lawn mower of the present invention also having a belt system that has a reversing gear, enabling the belt system to travel in two opposite directions. The belt system driving a plurality of reversible, double-edged cutting blades having a fin that facilitates air flow in the direction of the cutting blade. The improved lawn mower also having a power coupling that can receive a lawn maintenance attachment.

### CROSS-REFERENCE TO RELATED APPLICATIONS

This application claims priority to U.S. Provisional Application Ser. No. 61/358,117, filed on Jun. 24, 2010 and entitled “Lawn Mower with Selectively Reversible Cutting Blades.” Priority to this prior application is expressly claimed and the disclosure of that application is hereby incorporated in its entirety.

### FIELD OF THE INVENTION

This invention relates generally to rotary lawn mowers, and more particularly to a system and method of exhausting cut grass out from under a rotary lawn mower through a discharge gate optionally on the left side, the right side or the rear of the deck.

### BACKGROUND OF THE INVENTION

Prior art rotary lawn mowers typically have one or more blades that rotate about a vertical axis in a single direction, creating a strong wind current under the mowing deck that carries all of the cut grass out one pre-determined side of the deck in a generally rearward direction or into a bag mounted on the mower deck for easy collection and disposal. For simplicity, where the word “mower” is used herein, it is understood to refer only to rotary-type lawn mowers as described. These existing mowers suffer from several drawbacks. First, they only use one side of the blade to cut grass, which causes the blades to need to be sharpened or replaced more often than necessary. Second, the fact that the direction of exhausted grass cannot be changed means that, in certain situations, extra care is needed to avoid exhausting cut grass into flower beds or mulched areas. Additionally, certain trim work, such as near a building, around a tree or near a driveway, must be done while the mower is traveling in one direction for several passes, which often requires multiple passes in the opposite direction where the grass is not being cut. This results in wasted time and gas and additional pollutants expelled into the air as a result of the engine combustion. Third, even though a bag can be attached to the mower such that cut grass can be caught and not exhausted, such a bag must be manually installed and the driver is not able to selectively choose either the bag or the side exhaust out of the bag without dismounting the mower to make the change.

In view of the foregoing, a need has been recognized in connection with improving upon the shortcomings and disadvantages of existing mowers.

### SUMMARY OF THE INVENTION

It is therefore an object of the invention to provide an improved mower and a two-sided cutting blade. A further object of the invention is to provide a mower with a system for reversing the direction of the cutting blade, which will enable a user to optionally select, without dismounting from the mower, whether to exhaust cut grass clippings out the side of the mower or out the back of the mower onto the grass or into a bag. A further object of the invention is to provide a mower with a system for allowing the user to optionally choose, while seated on the mower, which side of the mower the grass will be exhausted.

### BRIEF DESCRIPTION OF THE DRAWINGS

FIG. 1 is a plan view of the top of a mower deck of the present invention.

FIG. 1A is a plan view of the top of a mower deck illustrating an alternative embodiment with an attachment.

FIG. 2a is a plan view of a double-edged blade of the present invention.

FIG. 2b is a cross-sectional view along line A-A in FIG. 4 of a double-edged blade of the present invention.

FIG. 3 is a plan view of the bottom of a mower deck of the present invention with the blades rotating in a manner to discharge grass clippings out either side gate.

FIG. 4 is a plan view of the bottom of a mower deck of the present invention with the blades rotating in a manner to discharge grass clippings through the rear chute.

### DETAILED DESCRIPTION OF THE PREFERRED EMBODIMENTS

The following description is provided to enable those skilled in the art to make and use the described embodiments set forth in the best modes contemplated for carrying out the invention. Various modifications, equivalents, variations, and alternatives, however, will remain readily apparent to those skilled in the art. Any and all such modifications, variations, equivalents and alternatives are intended to fall within the spirit and scope of the present invention.

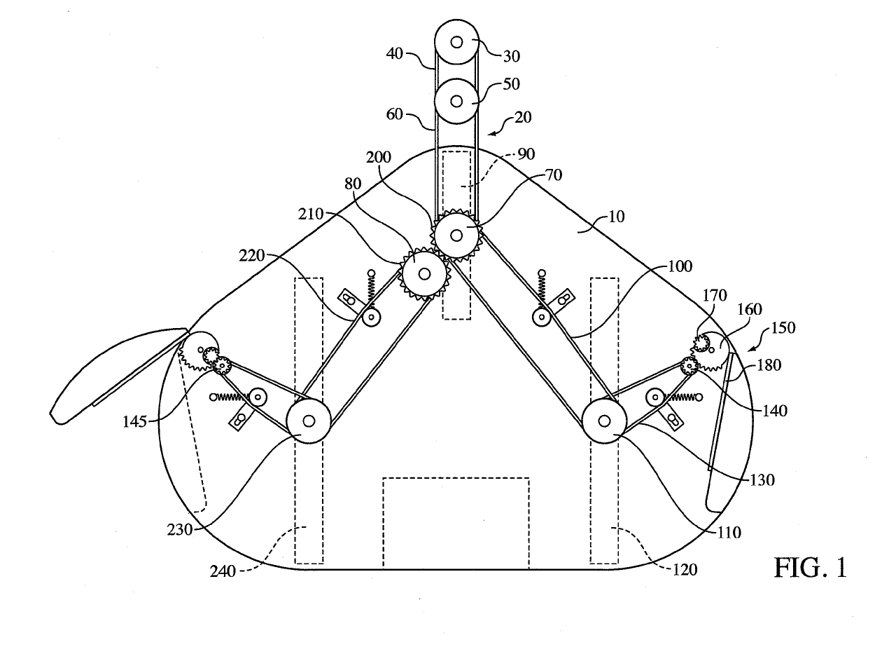

FIGS. 1, 3 and 4 illustrate a mower deck for a lawn mower. As is well known in the art, lawn mowers typically have the mower deck attached beneath a frame that also supports at least a motor and a set of wheels. As used herein, the term “mower deck” refers to a housing that holds one or plurality of blades and has one or plurality of exhaust doors or chutes through which grass clippings can be removed after being cut and is generally referred to herein as item 10. As is also known in the art, the mower includes a power take off (“PTO”) pulley that is rotationally driven by the motor and, in turn, drives a belt and pulley drive system on the top of the mower deck and further having cutting blades that are driven by the pulleys underneath the mower deck and embodying various aspects of the present invention. Also well known in the art, the motor drives the PTO via an extending shaft and also provides for propulsion of the mower via a drive system and transmission that connects the motor to the wheels. It will be readily apparent to those skilled in the art, however, that the mower disclosed herein represents but one of a wide variety of structures, configurations and modes of operation of mowers that fall within the scope of the present invention.

In accordance with a presently preferred embodiment of the present invention, FIG. 1 illustrates the top of a mower deck 10 constructed in accordance with the present invention. On top of the mower deck 10, a belt and pulley drive system 20 is used to transfer power from a motor to the blades and other elements of the mower as is well known in the art. A main PTO pulley 30 drives a first belt 40 when it is engaged. The first belt 40, in turn, drives a first reversing gear box pulley 50 connected to a reversing gear box (not shown) of the type well known in the art. The reversing gear box includes a second reversing gear box pulley (not shown) that drives a second belt 60 in either a clockwise or counter-clockwise direction. Preferably, the direction of the second belt 60 can be selectively reversed by a user from a seated position on the mower.

The second belt 60 drives a middle blade pulley 70 that is preferably fixably connected to a middle cutting blade 90. The middle blade pulley 70 uses third belt 100 to drive a right blade pulley 110, which is preferably fixably connected to a right cutting blade 120. The right blade pulley 110 uses a fourth belt 130 to drive a right blade PTO pulley (not shown). When the right blade PTO pulley is selectively engaged by the user, a right door pinion 140 is engaged by the right blade PTO pulley and actuates the right exhaust door assembly 150 by engageably rotating a right half gear 160 until the pinion 140 reaches a captured free gear 170 and is permitted to spin freely with the captured free gear 170. A door bar 180, fixably disposed on the right half gear 160 causes the right exhaust door assembly 150 to move to an open position when the right half gear 160 rotates as described above. Preferably, an electronically controlled magnet (not shown) keeps the door bar 180 in an open position so long as the right blade PTO pulley is engaged. Conversely, when the right blade PTO pulley is deselected or turned off by the user, the electromagnet is shut off and the right door bar 180 is pulled shut by a spring (not shown). In one embodiment, the spring is a torsional spring that is coaxial with the half gear 160, although other embodiments will be obvious to those skilled in the art.

Turning now to the operation of the other side of the mower deck 10, a reversing pulley 80 is mounted adjacent to the middle blade pulley 70 and is driven by the engagement of middle blade pulley teeth 200 with reversing pulley teeth 210 in order to both drive the reversing pulley 80 and reverse the direction of the fifth belt 220 when compared to the third belt 100. The fifth belt 220 drives the rotation of the left blade pulley 230 that is preferably fixably connected to a left cutting blade 240. The remainder of the apparatus on the left side are mirror images of the right side and function in the same way as their right side counterparts.

In an alternative embodiment, it is also apparent that accessories can be run off of the rotation of the pinions 140, 145. As further demonstrated in FIG. 1A, left door pinion 145 can additionally have a slave pulley mounted directly on top of it (not shown) such that it fixably rotates about the same axis and with the same speed as the left door pinion 145. The slave pulley, also referred to as a power coupling, could then be used to drive a number of useful lawn maintenance attachments, such as a trimmer 400, via a seventh belt 410. Alternatively, other accessories, including, but not limited to a blower (not shown) could be attached and operated in this manner.

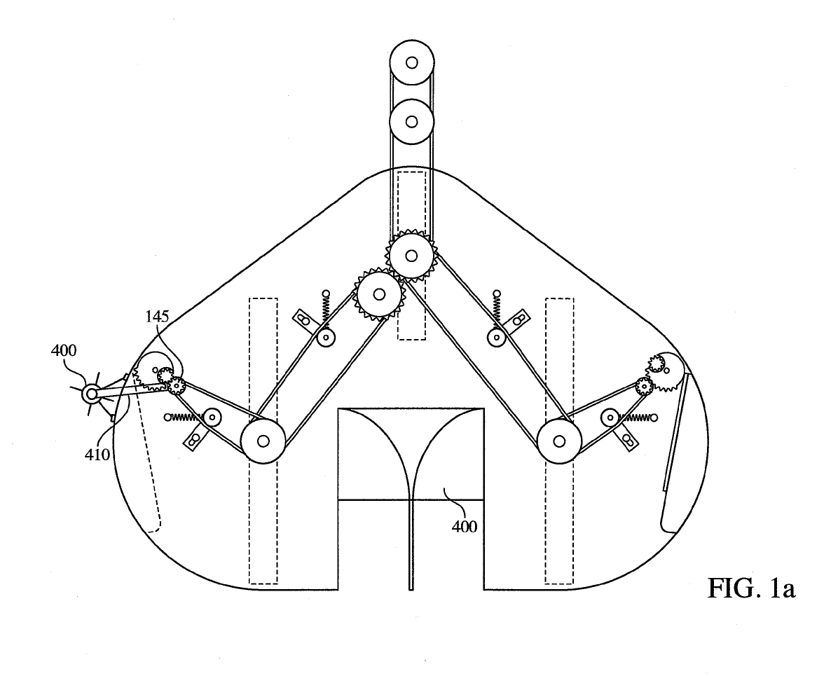

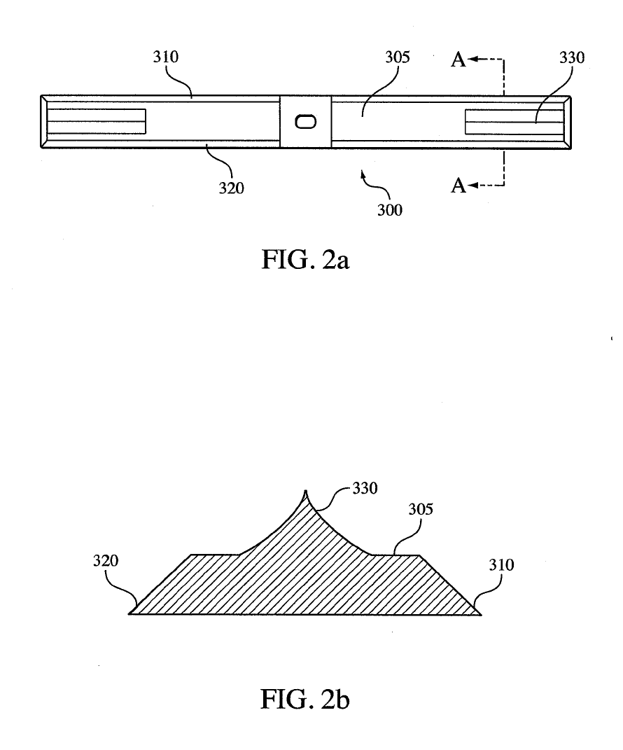

Due to the fact that the new and improved mower of the present invention can discharge grass clippings out either side or to the rear of the mower deck 10, the blades were designed to be able to cut grass in either direction. To accomplish this, FIGS. 2a and 2b illustrate a new cutting blade 300 for use with the mower of the present invention that has two cutting edges. This double-edged cutting blade 300 has a first cutting edge 310 and a second cutting edge 320 to enable cutting of grass regardless of which direction the blades rotate. Additionally, a fin 330 is disposed on a top portion 305 of the blade 300 and, when rotated, generates an air current that delivers cut grass clippings toward an intended exhaust chute. FIG. 2b shows a cross-section of a preferred embodiment of the blade 300 of the present invention along line A-A in FIG. 2a. The first cutting edge 310 and the second cutting edge 320 can be seen, along with the fin 330 disposed on the top portion 305 of the blade 300. While the fin 330 is demonstrated in FIG. 2 to be in a certain location on the top portion 305, and is illustrated having a certain cross sectional shape, those skilled in the art will recognize that there are a number of different locations and shapes that will generate an air current when the blades rotate such that cut grass clippings will be expelled from beneath the mower deck.

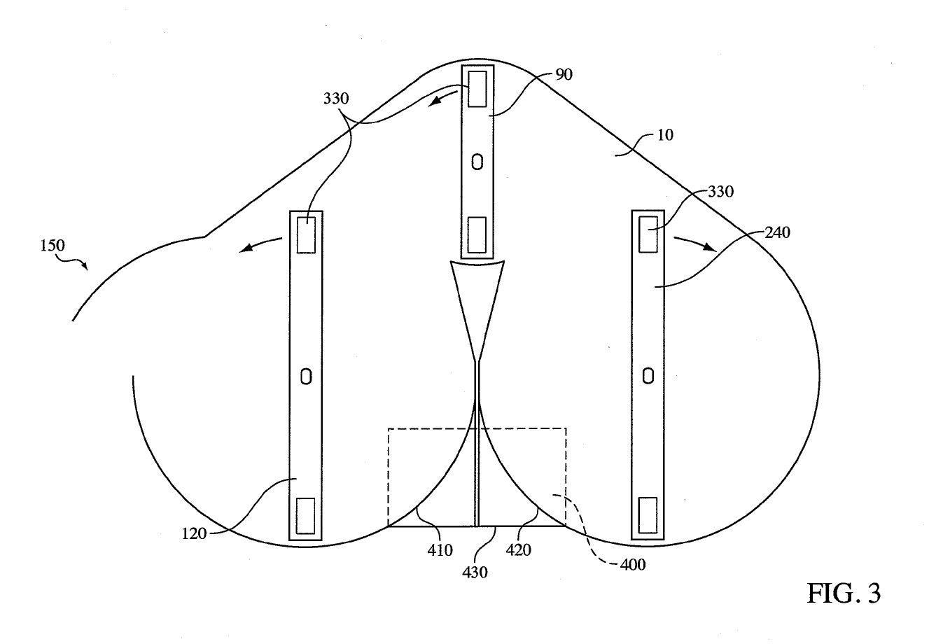

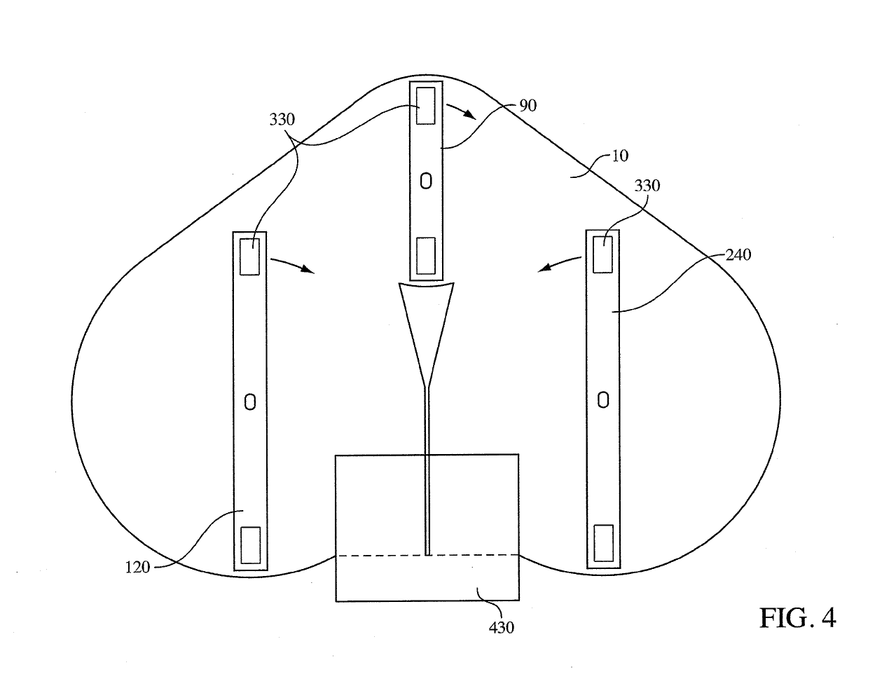

Referring now to FIGS. 3 and 4, a plan view of the bottom of the mower deck 10 is shown with the right, middle and left cutting blades 120, 90, 240 operating in side discharge mode in FIG. 3 and in rear discharge mode in FIG. 4. In FIG. 3, the left cutting blade 240 (which is on the right side due to the fact that this is a plan view of the bottom of the mower deck 10) rotates in a clockwise direction, while the right cutting blade 120 and the middle cutting blade 90 rotate in a counter-clockwise direction. In this side discharge mode, both the left cutting blade 240 and the right cutting blade 120, in conjunction with the fins 330 create an airflow pattern that pushes the cut grass toward the left and right exhaust door assemblies. Referring to FIG. 3, the user has opted to discharge grass out the right side of the mower deck 10 and the right exhaust door assembly 150 is open. In a preferred embodiment, a user may optionally select to discharge grass clippings out the left side of the mower deck 10, in which case the right door bar 180 would be released and the right exhaust door assembly 150 would close and the left side PTO would engage and open the left exhaust door assembly instead. Notably, when either of the side door exhaust assemblies are chosen, a baffle apparatus 400 is inserted at the rear of the mower deck 10. The baffle apparatus 400 comprises a first curved baffle 410 and a second curved baffle 420 to block ejection of cut grass clippings out a rear exhaust door 430 and ensure optimal air flow for side discharge. When rear discharge mode is selected, the baffle apparatus 400, which is hingedly connected to the mower deck 10 can be manually flipped up and out of the way onto the top of the mower deck as shown in FIG. 1A. In this situation, both side door assemblies would be closed and the direction of the blades would be reversed to optimize air flow toward the rear door 430 as will be further discussed below.

FIG. 4 further demonstrates the configuration for the discharge of cut grass clippings out the rear exhaust door 430, which is hingedly connected to the mower deck 10 under the seat of the mower (not shown). In this configuration, the grass clippings will be ejected out the rear of the mower where they can either be deposited into a bag for later disposal as is common in the art or deposited on the ground. When the grass is being caught for later disposal, in a preferred embodiment, a rear chute (not shown) is inserted into void left by the flipped up baffle apparatus in the rear or of the mower deck and extends upward away from the mower deck 10 at an approximately forty-five degree angle where it deposits the grass clippings into a carrying container or bag (not shown). When the user chooses to discharge cut grass clippings out the rear door 430, whether to be caught or discharged on the ground behind the mower, an electronic, hydraulic or other signal is sent to the reversing gear box pulley 50 of FIG. 1 that reverses the direction of the second belt 60 of FIG. 1, which, in turn, reverses the direction of all other belts under the mower deck 10 and, correspondingly, changes the direction of the rotation of all of the cutting blades 90, 120, 240. Due to the air currents generated by the fins 330, the cut grass clippings are now directed toward the rear chute 15 of the mower deck 10. The rear chute 15 has doors (not shown) that can be opened manually, electronically, hydraulically or due to the air pressure and grass clippings pushed against them when the mower is in rear discharge mode as is well known in the art.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An improved lawn mower comprising:
a frame;
a motor disposed on the frame;
a mower deck disposed on the frame;
a drive system disposed on the mower deck, said drive system being in rotational communication with the motor;
one or a plurality of cutting blades in operable communication with the drive system, whereby said cutting blades can be selectively rotated in a first and a second direction by the drive system.

2. The improved lawn mower of claim 1, wherein the drive system is comprised of one or plurality of interconnected belts and pulleys; at least one of said pulleys being in rotational communication with the one or a plurality of cutting blades.

3. The improved lawn mower of claim 2, wherein the drive system further comprises one or a plurality of reversing gears that enable the drive system and the cutting blades to rotate in a first direction and a second direction.

4. The improved lawn mower of claim 3, wherein the mower deck comprises at least a right exhaust door, a left exhaust door and a rear exhaust door to permit the ejection of cut grass clippings out either side or to the rear of the mower.

5. The improved lawn mower of claim 4, wherein the direction the cutting blades rotate depends on the selection of the door through which the cut grass clippings are to be ejected.

6. The improved lawn mower of claim 4, further comprising means for selectively opening one of the left exhaust door, the right exhaust door and the rear exhaust door.

7. The improved lawn mower of claim 1, wherein the mower deck comprises at least a right exhaust door and a left exhaust door, whereby grass clippings may be selectively removed from beneath the mower deck through either door at the option of the user.

8. The improved lawn mower of claim 7, wherein the mower deck further comprises a rear door.

9. The improved lawn mower of claim 1, wherein the one or plurality of cutting blades have a first and a second cutting edge and a top portion.

10. The improved lawn mower of claim 9, wherein the one or a plurality of cutting blades further have a fin disposed on the top portion to provide additional air flow in the direction of the cutting blade and assist the exhaust of grass clippings from beneath the mower deck.

11. The improved lawn mower of claim 1, further comprising a power coupling wherein said power coupling may optionally receive and drive a lawn maintenance attachment.

12. The improved lawn mower of claim 11, wherein the lawn maintenance attachment comprises a weed trimmer.

13. The improved lawn mower of claim 11, wherein the lawn maintenance attachment comprises a forced air blower.

14. A double-edged cutting blade for a lawn mower having a mower deck, the blade having a first cutting edge and a second cutting edge, whereby the blade can cut grass in a first rotated direction and a second rotated direction.

15. The double-edged cutting blade of claim 14, further comprising a top portion and a fin disposed on said top portion for generating an air current to expel cut grass from the mower deck.

16. In a lawn mower having a motor that powers a belt and pulley drive system driving one or more cutting blades and at least one exhaust door for expelling cut grass clippings, the improvement comprises a reversible belt system for driving one or more cutting blades in two directions, a cutting blade with two cutting edges and a plurality of exhaust doors for selectively discharging grass clippings on either side or to the rear of the mower.
